(19) United States
(12) Patent Application Publication
(10) Pub. No.: US 2021/0266682 A1
(43) Pub. Date: Aug. 26, 2021

(54) HEARING SYSTEM HAVING AT LEAST ONE HEARING INSTRUMENT WORN IN OR ON THE EAR OF THE USER AND METHOD FOR OPERATING SUCH A HEARING SYSTEM

(71) Applicant: Sivantos Pte. Ltd., Singapore (SG)

(72) Inventors: Rosa-Linde Fischer, Erlangen (DE); Ronny Hannemann, Buckenhof (DE)

(21) Appl. No.: 17/186,238

(22) Filed: Feb. 26, 2021

(30) Foreign Application Priority Data
Feb. 26, 2020 (DE) 102020202483.9

(51) Int. Cl. H04R 25/00; G06F 3/16; G10L 15/02

(52) U.S. Cl. CPC H04R 25/505; G10L 15/02; G06F 3/167

(57) ABSTRACT

A hearing system for assisting the sense of hearing of a user has a hearing instrument worn in or on the ear. In operation a sound signal is received from an environment by an input transducer and modified in a signal processing step. The modified sound signal is output by an output transducer. In an analysis step, foreign speech intervals are recognized in which the received sound signal contains speech of a speaker different from the user. The recognized foreign speech intervals are assigned to various identified speakers. For each recognized foreign speech interval, the respective assigned speaker is classified in the course of an interaction classification as to whether this speaker is in a direct communication relationship with the user as a main speaker or whether this speaker is not in a direct communication relationship with the user as a secondary speaker.

### CROSS-REFERENCE TO RELATED APPLICATION

This application claims the priority, under 35 U.S.C. § 119, of German Patent Application DE 10 2020 202 483.9, filed Feb. 26, 2020; the prior application is herewith incorporated by reference in its entirety.

### BACKGROUND OF THE INVENTION

### Field of the Invention

The invention relates to a method for operating a hearing system for assisting the sense of hearing of a user, having at least one hearing instrument worn in or on the ear of the user. The invention furthermore relates to such a hearing system.

Hearing instrument generally refers to an electronic device which assists the sense of hearing of a person (who is referred to hereinafter as a “wearer” or “user”) wearing the hearing instrument. In particular, the invention relates to hearing instruments which are configured to entirely or partially compensate for a hearing loss of a hearing-impaired user. Such a hearing instrument is also referred to as a “hearing aid”. In addition, there are hearing instruments which protect or improve the sense of hearing of users having normal hearing, for example are to enable improved speech comprehension in complex hearing situations.

Hearing instruments in general, and especially hearing aids, are usually configured to be worn in or on the ear of the user, in particular as behind-the-ear devices (also referred to as BTE devices) or in-the-ear devices (also referred to as ITE devices). With respect to their internal structure, hearing instruments generally include at least one (acousto-electrical) input transducer, a signal processing unit (signal processor), and an output transducer. In operation of the hearing instrument, the input transducer receives airborne sound from the surroundings of the hearing instrument and converts this airborne sound into an input audio signal (i.e., an electrical signal which transports information about the ambient sound). This input audio signal is also referred to hereinafter as the “received sound signal”. The input audio signal is processed (i.e., modified with respect to its sound information) in the signal processing unit in order to assist the sense of hearing of the user, in particular to compensate for a hearing loss of the user. The signal processing unit outputs a correspondingly processed audio signal (also referred to as the “output audio signal” or “modified sound signal”) to the output transducer. In most cases, the output transducer is configured as an electro-acoustic transducer, which converts the (electrical) output audio signal back into airborne sound, wherein this airborne sound—modified in relation to the ambient sound—is emitted into the auditory canal of the user. In the case of a hearing instrument worn behind the ear, the output transducer, which is also referred to as a “receiver”, is usually integrated outside the ear into a housing of the hearing instrument. The sound output by the output transducer is conducted in this case by means of a sound tube into the auditory canal of the user. Alternatively thereto, the output transducer can also be arranged in the auditory canal, and thus outside the housing worn behind the ear. Such hearing instruments are also referred to as RIC (“receiver in canal”) devices. Hearing instruments worn in the ear, which are dimensioned sufficiently small that they do not protrude to the outside beyond the auditory canal, are also referred to as CIC (“completely in canal”) devices.

In further constructions, the output transducer can also be designed as an electromechanical transducer which converts the output audio signal into structure-borne sound (vibrations), wherein this structure-borne sound is emitted, for example into the skull bone of the user. Furthermore, there are implantable hearing instruments, in particular cochlear implants, and hearing instruments, the output transducers of which directly stimulate the auditory nerve of the user.

The term “hearing system” refers to a single device or a group of devices and possibly nonphysical functional units, which together provide the functions required in operation of a hearing instrument. The hearing system can consist of a single hearing instrument in the simplest case. Alternatively thereto, the hearing system can comprise two interacting hearing instruments for supplying both ears of the user. In this case, this is referred to as a “binaural hearing system”. Additionally or alternatively, the hearing system can comprise at least one further electronic device, for example a remote control, a charging device, or a programming device for the or each hearing aid. In modern hearing systems, a control program, in particular in the form of a so-called app, is often provided instead of a remote control or a dedicated programming device, wherein this control program is configured for implementation on an external computer, in particular a smartphone or tablet. The external computer itself is regularly not part of the hearing system and in particular is generally also not provided by the producer of the hearing system.

A frequent problem of hearing-impaired users and—to a lesser extent—also of users having normal hearing is that conversation partners in hearing situations in which multiple persons speak (multispeaker environments) are understood poorly. This problem can be partially remedied by direction-dependent damping (beamforming) of the input audio signal. Corresponding algorithms are regularly set so that they selectively highlight a component of the ambient sound coming from the front over other noise sources, so that the user can better understand a conversation partner as long they face toward him. Such signal processing disadvantageously restricts the user in his options for interacting with the environment, however. For example, the user cannot turn the head away from the conversation partner during a conversation, without running the risk of losing the thread. Furthermore, a conventional direction-dependent damping also increases the risk that the user will not understand or will even not notice other persons who wish to participate in the conversation but are located outside the directional lobe.

### BRIEF SUMMARY OF THE INVENTION

The application is based on the object of enabling better speech comprehension for users of a hearing system, in particular in a multispeaker environment.

With respect to a method, this object is achieved according to the invention by the features of the independent method claim. With respect to a hearing aid system, the object is achieved according to the invention by the features of the independent heating aid system claim. Advantageous embodiments or refinements of the invention, which are partially inventive considered as such, are specified in the dependent claims and the following description.

The invention generally relates to a hearing system for assisting the sense of hearing of a user, wherein the hearing system includes at least one hearing instrument worn in or on an ear of the user. As described above, in simple embodiments of the invention, the hearing system can consist exclusively of a single hearing instrument. However, the hearing system preferably contains at least one further component in addition to the hearing instrument, for example a further (in particular equivalent) hearing instrument for supplying the other ear of the user, a control program (in particular in the form of an app) for execution on an external computer (in particular a smartphone) of the user, and/or at least one further electronic device, for example a remote control or a charging device. The hearing instrument and the at least one further component have a data exchange with one another, wherein functions of data storage and/or data processing of the hearing system are divided among the hearing instrument and the at least one further component.

The hearing instrument includes at least one input transducer for receiving a sound signal (in particular in the form of airborne sound) from surroundings of the hearing instrument, a signal processing unit for processing (modifying) the received sound signal to assist the sense of hearing of the user, and an output transducer for outputting the modified sound signal. If the hearing system includes a further hearing instrument for supplying the other ear of the user, this further hearing instrument preferably also includes at least one input transducer, a signal processing unit, and an output transducer. Instead of a second hearing instrument having input transducer, signal processing unit, and output transducer, a hearing instrument can also be provided for the second ear which does not have an output transducer itself, but only receives sound and—with or without signal processing—relays it to the hearing instrument of the first ear. Such so-called CROS or BiCROS instruments are used in particular in the case of users having one-sided deafness.

The or each hearing instrument of the hearing system is provided in particular in one of the constructions described at the outset (BTE device having internal or external output transducer, ITE device, for example CIC device, hearing implant, in particular cochlear implant, etc.). In the case of a binaural hearing system, both hearing instruments are preferably designed equivalently.

The or each input transducer is in particular an acousto-electrical transducer, which converts airborne sound from the surroundings into an electrical input audio signal. To enable direction-dependent analysis and processing of the received sound signal, the hearing system preferably contains at least two input transducers, which can be arranged in the same hearing instrument or—if provided—can be allocated to the two hearing instruments of the hearing system. The output transducer is preferably configured as an electro-acoustic transducer (receiver), which converts the audio signal modified by the signal processing unit back into airborne sound. Alternatively, the output transducer is configured to emit structure-borne sound or to directly stimulate the auditory nerve of the user.

The signal processing unit preferably contains a plurality of signal processing functions, which are applied to the received sound signal, i.e., the input audio signal, in order to prepare it to assist the sense of hearing of the user. The signal processing functions comprise in particular an arbitrary selection from the functions frequency-selective amplification, dynamic compression, spectral compression, direction-dependent damping (beamforming), interference noise suppression, for example classical interference noise suppression by means of a Wiener filter or active interference noise suppression (active noise cancellation, abbreviated ANC), active feedback suppression (active feedback cancellation, abbreviated AFC), wind noise suppression, voice recognition (voice activity detection), recognition or preparation of one's own voice (own voice detection, own voice processing), tinnitus masking, etc. Each of these functions or at least a majority of these functions is parameterizable here by one or more signal processing parameters. Signal processing parameter refers to a variable which can be assigned different values in order to influence the mode of action of the associated signal processing function. A signal processing parameter in the simplest case can be a binary variable, using which the respective function is switched on and off. In more complex cases, hearing aid parameters are formed by scalar floating point numbers, binary or continuously variable vectors, or multidimensional arrays, etc. One example of such signal processing parameters is a set of amplification factors for a number of frequency bands of the signal processing unit, which define the frequency-dependent amplification of the hearing instrument.

In the course of the method executed by means of the hearing system, a sound signal is received from the surroundings of the hearing instrument by the at least one input transducer of the hearing instrument. The received sound signal (input audio signal) is modified in a signal processing step to assist the sense of hearing of a user. The modified sound signal is output by means of the output transducer of the hearing instrument.

According to the method, in an analysis step, speech intervals are recognized by analysis of the received sound signal, in which the received sound signal contains (spoken) speech of a speaker different from the user.

Speech interval refers here and hereinafter in general to a chronologically limited section of the received sound signal which contains spoken speech. Speech intervals which contain speech of the user himself are referred to here as “own speech intervals”. In contrast thereto, speech intervals which contain speech of at least one speaker different from the user, independently of the language—i.e., independently of whether the speaker speaks English, German, French, etc.—are referred to as “foreign speech intervals”.

To avoid linguistic ambiguities, only the persons different from the user are referred to hereinafter as a speaker (talker). The user himself is thus not included here and hereinafter among the “speakers”, even if he speaks.

According to the invention, various speakers are identified in recognized foreign speech intervals in the analysis step by analysis of the received sound signal. The word “identify” is used here in the meaning that each of the identified speakers is recognizably differentiated from other speakers. In the analysis step, each recognized foreign speech interval is assigned to the speaker who speaks in this foreign speech interval. Preferably, signal components of persons speaking simultaneously (for example signal components of the user and at least one speaker or signal components of multiple speakers) are separated from one another by signal processing and processed separately from one another. An own speech interval and a foreign speech interval or foreign speech intervals of various speakers can overlap in time. In alternative embodiments of the invention, time periods of the received sound signal are always only assigned to one of the participating speakers even if they contain speech components of multiple persons.

According to the invention, for each recognized foreign speech interval, the assigned speaker is classified in the course of an interaction classification as to whether or not this speaker has a direct communication relationship with the user. Speakers who have a direct communication relationship with the user are referred to hereinafter as a “main speaker” (main talker). Speakers who do not have a direct communication relationship with the user are referred to hereinafter as a “secondary speaker” (secondary talker). “Communication” refers here and hereinafter to an at least attempted (intentional or unintentional) information transfer between a speaker and the user by spoken speech. A direct communication relationship is given if information is transferred directly (without mediation by further persons or means) between the speaker and the user. In particular four cases of a direct communication relationship are relevant for the present method, namely:

a) firstly the case in which the user and the speaker mutually speak with one another,
b) secondly the case in which the speaker directly addresses the user and the user intentionally listens to the speaker,
c) thirdly the case in which the speaker directly addresses the user, but the user does not intentionally listen to the speaker (this comprises above all the case in which the user does even not notice the speaker and his communication with the user), and
d) fourthly the case in which the speaker does not directly address the user but the user intentionally listens to the speaker.

Conversely, a direct communication relationship does not exist if the speaker does not directly address the user and the user also does not intentionally listen to the speaker.

In a multispeaker environment, each of the multiple speakers can be classified as a main speaker or as a secondary speaker. There can thus be multiple main speakers and/or multiple secondary speakers simultaneously. The interaction classification is furthermore carried out in a time-resolved manner. An identified speaker can therefore change his status as a main speaker or secondary speaker, depending on his current communication relationship with the user. A speaker heretofore classified as a secondary speaker accordingly becomes the main speaker if a direct communication relationship arises between him and the user. A speaker heretofore classified as a main speaker also becomes a secondary speaker if the direct communication relationship between him and the user ends (for example if the speaker and the user each permanently face toward other conversation partners).

In dependence on this interaction classification (i.e., depending on whether the speaker assigned to a recognized foreign speech interval was classified as a main speaker or as a secondary speaker), the modification of the recognized foreign speech intervals is carried out in different ways in the signal processing step, in particular with application of different settings of the signal processing parameters. For example, the direction-dependent damping (beamforming) is applied to a stronger extent to foreign speech intervals which are assigned to a speaker identified as a main speaker than to foreign speech intervals which are assigned to a secondary speaker. In other words, the directional lobe of the beamformer is preferably and particularly significantly aligned on a speaker identified as a main speaker, while signal components of secondary speakers are preferably processed in a damped manner or with low or without directional effect.

The classification of the identified speakers into main and secondary speakers and the different signal processing of foreign speech intervals in dependence on this (interaction) classification enables components of the received sound signal which originate from main speakers to be particularly highlighted and thus made better or more easily perceptible for the user.

The interaction classification is based in one advantageous embodiment of the method on an analysis of the spatial orientation of the or each identified speaker in relation to the user and in particular his head orientation. In the analysis step, the spatial orientation and optionally a distance of the speaker in relation to the head of the user is detected and taken into consideration in the interaction classification for at least one identified speaker (preferably for each identified speaker). For example, in this case the finding that a user faces toward an identified speaker particularly frequently and/or for a long time, so that this speaker is predominantly arranged on the front side with respect to the head of the user, is assessed as an indication that this speaker is to be classified as a main speaker. A speaker who is always or at least predominantly arranged laterally or to the rear with respect to the head of the user, in contrast, tends to be classified as a secondary speaker.

If the distance of the identified speakers is also taken into consideration in the interaction classification, a distance of the speaker within a defined distance range is assessed as an indication that this speaker is a main speaker. A speaker who is located at a comparatively large distance from the head of the user, in contrast, is classified with higher probability as a secondary speaker.

Additionally or alternatively to the spatial orientation, the sequence in which foreign speech intervals and own speech intervals alternate with one another (turn-taking) is preferably also taken into consideration for the interaction classification. Own speech intervals in which the user speaks are also recognized in this case in the analysis step. For at least one (preferably for each) identified speaker, a chronological sequence of the assigned foreign speech intervals and the recognized own speech intervals is detected and taken into consideration in the interaction classification. A speaker whose assigned foreign speech components alternate with own speech components without overlap or with only comparatively little overlap and comparatively short interposed speech pauses tends to be classified as a main speaker, since such turn-taking is assessed as an indication that the speaker is in a mutual conversation with the user. Foreign speech intervals which are chronologically uncorrelated with own speech intervals (which have on average a large overlap with own speech intervals, for example), are assessed in contrast as foreign speech intervals of secondary speakers.

Optionally, furthermore the turn-taking between two speakers (different from the user) is also analyzed and taken into consideration for the interaction classification. Foreign speech intervals of various speakers who alternate with one another without overlap or with only slight overlap in a chronologically correlated manner are assessed as an indication that the speakers assigned to these foreign speech intervals are in a conversation with one another and thus—in the absence of other indications of a passive or active participation of the user—are to be classified as secondary speakers.

Again additionally or alternatively, the interaction classification in preferred embodiments of the invention takes place on the basis of the volume and/or the signal-to-noise ratio of the received sound signal. In the analysis step, an averaged volume (level) and/or a signal-to-noise ratio is ascertained for each recognized foreign speech interval and taken into consideration in the interaction classification. Foreign speech intervals having volume in a predetermined range or comparatively good signal-to-noise ratio tend to be assigned to a main speaker, while a comparatively low volume or a low signal-to-noise ratio during a foreign speech interval is assessed as an indication that the assigned speaker is a secondary speaker. In one advantageous embodiment, chronological changes in the spatial distribution of the speakers (varying speaker positions or varying number of speakers) are analyzed in the interaction classification.

Again additionally or alternatively, preferably a physiological reaction of the user during a foreign speech interval is taken into consideration in the interaction classification. The physiological reaction, i.e., a chronological change of a detected physiological measured variable (for example the pulse rate, the skin resistance, the body temperature, the state of the ear muscle, the eye position, and/or the brain activity), is ascertained in particular here by means of at least one biosensor integrated into the hearing system or external biosensor, for example a heart rate monitor, a skin resistance measuring device, a skin thermometer, or an EEG sensor, respectively. A significant physiological reaction of the user during a foreign speech interval, i.e., a comparatively large change of the detected physiological measured variable is assessed as an indication that the speaker assigned to this foreign speech interval is a main speaker. A speaker, upon the foreign speech intervals of which no significant physiological reaction of the user takes place, has a tendency to be classified as a secondary speaker, in contrast.

Furthermore, behavior patterns are advantageously also analyzed and used for the interaction classification, for example changes in the pattern of the head and torso movements, movement in space (approach or distancing with respect to foreign speakers), changes in the mode of speech (in particular the intensity, tonality, speech rate/number of words per unit of time), or speech time, change of the seat position, comprehension questions, selection of the dialogue partners, etc. For example, the behavior of the user with respect to his selection of specific foreign speakers within the potential main speakers ascertained on the basis of the distance or directional analysis can be analyzed. The disproportionately more frequent interaction with a close speaker or the fixation on a specific speaker (recognized from a low level or absence of head movements), while the user fixes less strongly on other speakers (recognized from more pronounced head movements) are evaluated, for example as an indication that various main speakers are perceived differently well.

Preferably, a combination of multiple of the above-described criteria (spatial distribution of the speakers, turn-taking, volume, and/or signal-to-noise ratio of the speech contributions and the physiological reaction of the user) and also optionally one or more further criteria is taken into consideration in the interaction classification. In this case, the interaction classification preferably takes place on the basis of a study of multiple criteria for coincidence (wherein, for example, a speaker is classified as a main speaker if multiple indications are fulfilled simultaneously) or on the basis of a weighted consideration of fulfilling or not fulfilling the multiple individual criteria.

The differing modification of the recognized foreign speech intervals of main speakers and secondary speakers in the signal processing step is expressed in preferred embodiments of the invention in that:

a) foreign speech intervals of the or each speaker classified as a main speaker are amplified to a greater extent than foreign speech intervals of the or each speaker classified as a secondary speaker,
b) foreign speech intervals of the or each speaker classified as a main speaker are dynamically compressed to a lesser extent than foreign speech intervals of the or each speaker classified as a secondary speaker (in particular are processed without compression),
c) foreign speech intervals of the or each speaker classified as a main speaker are subjected to less interference noise reduction (Active Noise Cancelling) than foreign speech intervals of the or each speaker classified as a secondary speaker, and/or
d) foreign speech intervals of the or each speaker classified as a main speaker are subjected to a greater extent to direction-dependent damping (beamforming) than foreign speech intervals of the or each speaker classified as a secondary speaker; the directional lobe of the beamforming algorithm is aligned in particular on the main speaker.

The difference in the processing of the voice components of main and secondary speakers is specified permanently (invariably) in expedient embodiments of the invention.

In one preferred variant of the invention, in contrast, this difference is changed as a function of the communication quality. A measure (i.e., a characteristic variable) is ascertained for the communication quality for the or each speaker classified as a main speaker, which is characteristic for the success of the information transfer between this main speaker and the user and/or for the listening effort of the user linked to this communication. The mentioned measure of the communication quality (in short also “quality measure”) has a comparatively high value, for example if the user registers the information transferred by a speaker classified as a main speaker without recognizably increased listening effort; in contrast, it has a comparatively low value if the user displays increased listening effort during foreign speech intervals of this main speaker, does not comprehensibly understand the information transferred by this main speaker, or does not notice this main speaker at all.

The quality measure is preferably a continuously-variable variable, for example a floating-point number, which can assume a value variable between two predetermined limits. Alternatively thereto, in simple embodiments of the invention, the quality measure can also be a binary variable. In each of the above-mentioned cases, the modification of the foreign speech intervals assigned to this main speaker is performed in the signal processing step as a function of the mentioned quality measure.

Preferably, identical or similar criteria are used in the determination of the quality measure as for the interaction classification. Thus, the quality measure is preferably ascertained:

a) on the basis of the spatial orientation and/or the distance of the main speaker in relation to the head of the user,
b) on the basis of the chronological sequence (turn-taking) of the foreign speech intervals assigned to the main speaker and of the recognized own speech intervals,
c) on the basis of the physiological reaction of the user during a foreign speech interval assigned to the main speaker,
d) on the basis of the volume of the voice component of the main speaker, and/or
e) on the basis of an evaluation of behavior patterns as described above.

Fixation on the main speaker by the user (i.e., unusually strong facing of the user toward the main speaker), an unusually short distance between the user and the main speaker, a physiological reaction of the user characteristic of an unusually high level of listening effort or frustration, and an increased volume of the voice of the main speaker are assessed as indications of a poor communication quality.

Additionally or alternatively, in one advantageous embodiment of the invention, a spectral property, in particular a fundamental frequency (pitch) of the voice of the user is ascertained for at least one own speech interval and/or a spectral property of the voice of the main speaker is ascertained for at least one foreign speech interval assigned to the main speaker. In these cases, the quality measure is ascertained (exclusively or at least also) on the basis of the spectral property of the voice of the user or on the basis of the spectral property of the voice of the main speaker, respectively. For example, a fundamental frequency of the voice of the user or the main speaker elevated over a normal value is assessed as an indication of a poor communication quality. This invention variant is based on the finding that the user or other speakers typically have the tendency to raise the voice in situations having poor communication quality.

Again additionally or alternatively, a volume of the received sound signal (in particular a volume of the own voice of the user or main speaker) is preferably ascertained for at least one own or foreign speech interval and taken into consideration in the determination of the quality measure. This invention variant is based on the experience that humans (and thus in particular also the user of the hearing system and the main speakers communicating with him) have the tendency to speak louder in situations having poor communication quality.

Again additionally or alternatively, a speech rhythm or the speech rate (speech speed) of the user is preferably ascertained for at least one own speech interval and/or a speech rhythm of the main speaker is ascertained for at least one foreign speech interval assigned to a main speaker. The speech rhythm of the user or the main speaker is taken into consideration in the determination of the quality measure. This invention variant is based on the finding that humans (and thus also the user of the hearing system and the main speakers communicating with him) tend in situations with poor communication quality to speak with a speech rhythm changed in comparison to normal situations. A poor communication quality is thus often expressed, for example in a slowed speech rhythm, since the user or other speakers attempt(s) to achieve better comprehension with the communication partner by speaking slowly. Situations having poor communication quality can also be linked, on the other hand, to an unusually accelerated speech rhythm as a consequence of dissatisfaction of the user or other speaker. An unusually increased or decreased speech rhythm of the user or main speaker is therefore assessed as an indication of poor communication quality.

The speech analysis unit preferably calculates the quality measure on the basis of a weighted analysis of the above-described indications. Alternatively thereto, the speech analysis unit sets the quality measure to a value indicating a poor communication quality if multiple of the above-mentioned indications are fulfilled simultaneously.

The hearing system according to the invention is generally configured for automatically carrying out the above-described method according to the invention. The hearing system is thus configured for the purpose of receiving a sound signal from an environment of the hearing instrument by means of the at least one input transducer of the at least one hearing instrument, modifying the received sound signal in the signal processing step to assist the sense of hearing of a user, and outputting the modified sound signal by means of the output transducer of the hearing instrument. The hearing system is furthermore configured for the purpose of recognizing foreign speech intervals in the analysis step, identifying various speakers in recognized foreign speech intervals, and assigning each foreign speech interval to the speaker who speaks in this foreign speech interval. The hearing system is finally also configured, for each recognized foreign speech interval, to classify the assigned speaker in the course of the interaction classification as a main speaker or as a secondary speaker, and, in the signal processing step, to carry out the modification of the recognized foreign speech intervals in different ways in dependence on the interaction classification (i.e., depending on whether the assigned speaker was classified as a main speaker or as a secondary speaker).

The device of the hearing system for automatically carrying out the method according to the invention is of a program and/or circuitry nature. The hearing system according to the invention thus comprises program means (software) and/or circuitry means (hardware, for example in the form of an ASIC), which automatically carry out the method according to the invention in operation of the hearing system. The program or circuitry means for carrying out the method can be arranged here exclusively in the hearing instrument (or the hearing instruments) of the hearing system. Alternatively, the program or circuitry means for carrying out the method are distributed to the hearing instrument or the hearing aids and to at least one further device or software component of the hearing system. For example, program means for carrying out the method are distributed to the at least one hearing instrument of the hearing system and to a control program installed on an external electronic device (in particular a smartphone).

The above-described embodiments of the method according to the invention correspond to corresponding embodiments of the hearing system according to the invention. The above statements on the method according to the invention are transferable correspondingly to the hearing system according to the invention and vice versa.

In preferred embodiments, the hearing system is configured in particular, in the analysis step:

a) for at least one (preferably for each) identified speaker, to detect a spatial orientation (and optionally a distance) of this speaker relative to the head of the user and to take it into consideration in the interaction classification,
b) to also recognize own speech intervals, for at least one (preferably for each) identified speaker, to detect a chronological sequence (turn-taking) of the assigned foreign speech intervals and the recognized own speech intervals, and to take it into consideration in the interaction classification,
c) for each recognized foreign speech interval, to ascertain an averaged volume and/or a signal-to-noise ratio and to take it into consideration in the interaction classification, and/or
d) for each recognized foreign speech interval, to detect a physiological reaction of the user and to take it into consideration in the interaction classification.

In further preferred embodiments, the hearing system is configured in particular, in the signal processing step:

a) to amplify foreign speech intervals of the or each speaker classified as a main speaker to a greater extent than foreign speech intervals of the or each speaker classified as a secondary speaker,
b) to dynamically compress foreign speech intervals of the or each speaker classified as a main speaker to a lesser extent than foreign speech intervals of the or each speaker classified as a secondary speaker (in particular not to compress them at all),
c) to subject foreign speech intervals of the or each speaker classified as a main speaker to less noise reduction (active noise canceling) and/or feedback suppression (active feedback canceling) than foreign speech intervals of the or each speaker classified as a secondary speaker, and/or
d) to subject foreign speech intervals of the or each speaker classified as a main speaker to direction-dependent damping (beamforming) to a greater extent than foreign speech intervals of the or each speaker classified as a secondary speaker.

In further preferred embodiments, the hearing system is configured in particular to detect a measure of the communication quality (quality measure) for the or each speaker classified as a main speaker and to perform the modification of the foreign speech intervals associated with this main speaker as a function of this quality measure.

The hearing system is configured in particular here to ascertain the quality measure in the above-described way:

a) on the basis of the spatial orientation (and/or the distance) of the main speaker relative to the head of the user,
b) on the basis of the chronological sequence (turn-taking) of the foreign speech intervals assigned to the main speaker and the recognized own speech intervals,
c) on the basis of the physiological reaction of the user during a foreign speech interval assigned to the main speaker,
d) on the basis of a spectral property, in particular the fundamental frequency, of the voice of the user and/or a main speaker,
e) on the basis of the volume of an own speech interval and/or a foreign speech interval (in particular on the basis of the volume of the user's own voice or the voice of the main speaker, respectively),
f) on the basis of the speech rhythm (speech speed) of the user and/or a main speaker, and/or
g) on the basis of an evaluation of behavior patterns as described above.

Other features which are considered as characteristic for the invention are set forth in the appended claims.

Although the invention is illustrated and described herein as embodied in a hearing system having at least one hearing instrument worn in or on the ear of the user and a method for operating such a hearing system it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic illustration of a hearing system containing a single hearing instrument in a form of a hearing aid wearable behind an ear of a user;

FIG. 2 is a flow chart of a method for operating the hearing system from FIG. 1;

FIG. 3 is a flow chart of an alternative embodiment of the method; and

FIG. 4 is an illustration according to FIG. 1 of an alternative embodiment of the hearing system, in which it contains a hearing instrument in the form of a hearing aid wearable behind the ear and a control program implemented in a smartphone.

### DETAILED DESCRIPTION OF THE INVENTION

Identical parts and variables are always provided with the same reference signs in all figures.

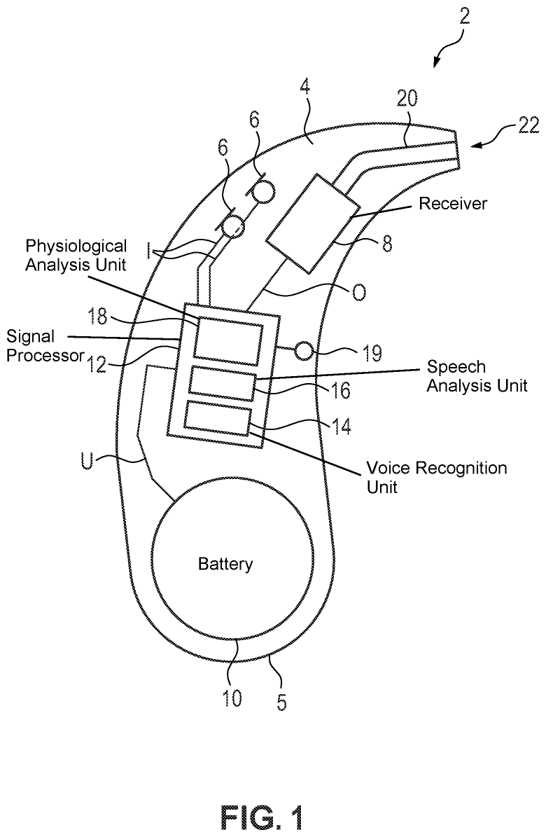

Referring now to the figures of the drawings in detail and first, particularly to FIG. 1 thereof, there is shown a hearing system 2 having a single hearing aid 4, i.e., a hearing instrument configured to assist the sense of hearing of a hearing-impaired user. The hearing aid 4 in the example shown here is a BTE hearing aid wearable behind an ear of a user.

Optionally, in a further embodiment of the invention, the hearing system 2 comprises a second hearing aid (not expressly shown) for supplying the second ear of the user.

The hearing aid 4 contains, inside a housing 5, at least one microphone 6 (in the illustrated example two microphones) as an input transducer and a receiver 8 as an output transducer. The hearing aid 4 furthermore has a battery 10 and a signal processing unit in the form of a signal processor 12. The signal processor 12 preferably contains both a programmable subunit (for example a microprocessor) and also a non-programmable subunit (for example an ASIC). The signal processor 12 contains a (voice recognition) unit 14 and a (speech analysis) unit 16. In addition, the signal processor 12 optionally includes a (physiology analysis) unit 18, which evaluates signals of one or more—also optional—biosensors 19, for example signals of a heart rate monitor, a skin resistance sensor, a body temperature sensor, and/or an EEG sensor.

The units 14 to 18 are preferably configured as software components, which are implemented to be executable in the signal processor 12. The or each biosensor 19 can be integrated in the hearing aid 2—as shown by way of example in FIG. 1. However, the physiology analysis unit 18 can additionally or alternatively also acquire signals from one or more external biosensors (i.e., arranged outside the housing 5).

The signal processor 12 is supplied with an electrical supply voltage U from the battery 10.

In normal operation of the hearing aid 4, the microphones 6 receive airborne sound from the environment of the hearing aid 4. The microphones 6 convert the sound into an (input) audio signal I, which contains information about the received sound. The input audio signal I is supplied inside the hearing aid 4 to the signal processor 12.

The signal processor 12 processes the input audio signal I while applying a plurality of signal processing algorithms, for example:

a) direction-dependent damping (beamforming),
b) interference noise and/or feedback suppression,
c) dynamic compression, and
d) frequency-dependent amplification based on audiogram data,

to compensate for the hearing loss of the user. The respective mode of operation of the signal processing algorithms, and thus of the signal processor 12, is determined by a plurality of signal processing parameters. The signal processor 12 outputs an output audio signal O, which contains information about the processed and thus modified sound, at the receiver 8.

The receiver 8 converts the output sound signal O into modified airborne sound. This modified airborne sound is transferred into the auditory canal of the user via a sound channel 20, which connects the receiver 8 to a tip 22 of the housing 5, and via a flexible sound tube (not explicitly shown), which connects the tip 22 to an earpiece inserted into the auditory canal of the user.

The voice recognition unit 14 generally detects the presence of voice (i.e., spoken speech, independently of the speaking person) in the input audio signal I. The voice recognition unit 14 thus does not distinguish between the voice of the user and the voice of another speaker and thus generally includes speech intervals, i.e., time intervals in which the input audio signal I contains spoken speech.

The speech analysis unit 16 evaluates the recognized speech intervals and determines therein:

a) the orientation of the speaking person with respect to the head of the user, in particular in that it compares the voice component in multiple differently oriented variants of the input audio signal I (beamformer signals) to one another or in that it sets the direction of greatest amplification or damping of a direction algorithm (beamformer) so that the voice component in the input audio signal I is maximized,
b) (an estimated value for) the distance of the speaking person with respect to the head of the user. In order to estimate this distance, the speech analysis unit 16 in particular evaluates the volume in combination with averaged angular velocities and/or amplitudes of the chronological change of the orientation of the speaking person. The orientation changes which are based on a head rotation of the user are preferably calculated out or left unconsidered in another way. In this evaluation, the speech analysis unit 16 considers that from the viewpoint of the user, the orientation of another speaker typically changes faster and more extensively the shorter the distance of this speaker is to the user. Additionally or alternatively, to estimate the distance, the speech analysis unit 16 evaluates the fundamental frequency and the ratio between the formants of vowels in speech intervals of the user and/or the foreign speakers. The speech analysis unit 16 uses the finding for this purpose that the above-mentioned variables of speakers are typically varied in a characteristic way in dependence on the distance to the respective listener (depending on the distance to the listener, the speaking person typically varies their manner of speech between whispering, normal manner of speech, and shouting to make themselves comprehensible). Furthermore, the hearing system 2 is preferably configured for the purpose of recognizing wirelessly communicating electronic mobile devices (for example, smartphones, other hearing aids, etc.) in the environment of the user, ascertaining the respective distance of the recognized devices, and using the detected distance values to ascertain or check the plausibility of the distance of the speaking person to the head of the user,
c) the fundamental frequency (pitch) of the input audio signal I or the voice component in the input audio signal I,
d) the speech rhythm (speaking speed) of the speaking person,
e) the level (volume) of the input audio signal I or the voice component in the input audio signal I, and/or
f) a signal-to-noise ratio of the input audio signal I.

On the basis of one or more of the above-mentioned variables, the speech analysis unit 16 differentiates the recognized speech intervals, on the one hand, into own speech intervals in which the user speaks and foreign speech intervals, in which a speaker (different from the user) speaks.

The speech analysis unit 16 recognizes own speech intervals in particular in that an unchanged orientation from the front with respect to the head of the user is ascertained for the voice component of the input audio signal I in these intervals.

In addition, the speech analysis unit 16, for the own voice recognition, optionally evaluates the fundamental frequency and/or the speech rhythm of the voice component and compares them, for example to stored reference values of the fundamental frequency or the speech rhythm of the user.

Again or alternatively, the speech analysis unit 16 applies other methods known per se for own voice recognition, as are known, for example, from U.S. patent publication No. 2013/0148829 A1 or from international patent disclosure WO 2016/078786 A1. Again additionally or alternatively, the speech analysis unit 16 uses, for own voice recognition, an item of structure-borne sound information or a received inner ear sound signal; this is based on the finding that the user's own voice is measured with significantly stronger component in the structure-borne sound transmitted via the body of the user or in the inner ear sound signal measured in the auditory canal of the user than in the input audio signal I corresponding to the ambient sound.

In addition, the speech analysis unit 16 evaluates recognized foreign speech intervals to distinguish various speakers from one another and thus to assign each foreign speech interval to a specific individual speaker.

For this purpose, the speech analysis unit 16 evaluates the analyzed foreign speech intervals, for example with respect to the fundamental frequency and/or the speech rhythm. In addition, the speech analysis unit 16 preferably also evaluates the orientation and possibly the distance of the detected speech signals in order to distinguish various speakers from one another. This evaluation uses the fact in particular that, on the one hand, the location of a speaker cannot change suddenly with respect to the head and in relation to other speakers and, on the other hand, two speakers cannot be at the same location simultaneously. The speech analysis unit 16 therefore evaluates constant or continuously varying orientation and distance values as an indication that the associated speech signals originate from the same speaker. Vice versa, the speech analysis unit 16 evaluates uncorrelated changed orientation and distance values of the respective voice component of two foreign speech intervals as an indication that the associated speech signals originate from different speakers.

The speech analysis unit 16 preferably creates profiles of recognized speakers having respective reference values for multiple of the above-mentioned variables (fundamental frequency, speech rhythm, orientation, distance) and determines in the analysis of each foreign speech interval whether the corresponding variables are compatible with the reference values from one of the profiles. If this is the case, the speech analysis unit 16 thus assigns the foreign speech interval to the respective profile (and thus the respective recognized speaker). Otherwise, the speech analysis unit 16 assumes that the analyzed foreign speech interval is to be assigned to a new (still unknown) speaker and creates a new profile for this speaker.

If multiple persons (for example the user and at least one further speaker or multiple speakers different from the user) speak simultaneously at one point in time, the speech analysis unit 16 preferably evaluates the respective voice components separately from one another by means of spatial source separation (with application of beamforming algorithms). In this case, multiple own and/or foreign speech intervals thus result, which chronologically overlap.

The speech analysis unit 16 furthermore records an item of information about the chronological length and sequence of the own speech intervals and the foreign speech intervals and also the speakers assigned to each of the foreign speech intervals. On the basis of this information, the speech analysis unit 16 ascertains characteristic variables which are relevant for the so-called turn-taking between own speech intervals and foreign speech intervals of a specific speaker. “Turn-taking” refers to the organization of the speech contributions of two speaking persons in a conversation, in particular the sequence of the speech contributions of these persons. Relevant parameters of “turn-taking” are in particular uninterrupted speech contributions (TURNS) of the speaking persons, overlaps (OVERLAPS), gaps (LAPSES), pauses (PAUSES), and alternations (SWITCHES), as they are defined, for example in S. A. Chowdhury, et al. “Predicting User Satisfaction from Turn-Taking in Spoken Conversations”, Interspeech 2016.

The speech analysis unit 16 in particular ascertains concretely:

a) the chronological length or chronological frequency of TURNS of the user and/or TURNS of the other speaker, wherein a TURN is an own or foreign speech interval without PAUSE, during which the respective speech partner is silent;
b) the chronological length or chronological frequency of PAUSES, wherein a PAUSE is an interval of the input audio signal I without speech component, which separates two successive TURNS of the user or two successive TURNS of the other speaker if the chronological length of this interval exceeds a predetermined threshold value; optionally, PAUSES between TURNS of the user and PAUSES between TURNS of the or each other speaker are each detected and evaluated separately from one another; alternatively thereto, all PAUSES are detected and evaluated jointly;
c) the chronological length or chronological frequency of LAPSES, wherein a LAPSE is an interval of the input audio signal I without speech component between a TURN of the user and a following TURN of the other speaker or between a TURN of the other speaker and a following TURN of the user, if the chronological length of this interval exceeds a predetermined threshold value; optionally, LAPSES between a TURN of the user and a TURN of the other speaker and LAPSES between a TURN of the other speaker and a TURN of the user are each detected and evaluated separately from one another; alternatively thereto, all LAPSES are detected and evaluated jointly;
d) the chronological length or chronological frequency of OVERLAPS, wherein an OVERLAP is an interval of the input audio signal I in which both the user and also the other speaker speak; preferably, such an interval is only evaluated as an OVERLAP if the chronological length of this interval exceeds a predetermined threshold value; optionally, OVERLAPS between a TURN of the user and a following TURN of the other speaker and OVERLAPS between a TURN of the other speaker and a following TURN of the user are each detected and evaluated separately from one another; alternatively thereto, all OVERLAPS are detected and evaluated jointly; and/or
e) the chronological frequency of SWITCHES, wherein a SWITCH is a transition from a TURN of the user to a TURN of the other speaker or a transition from a TURN of the other speaker to a following TURN of the user without OVERLAP or interposed PAUSE, thus in particular a transition within a specific chronological threshold value; optionally, SWITCHES between a TURN of the user and a TURN of the other speaker and SWITCHES between a TURN of the other speaker and a following TURN of the user are detected and evaluated separately from one another; alternatively thereto, all SWITCHES are detected and evaluated jointly.

The characteristic variables relevant for the “turn-taking” are ascertained separately for each recognized speaker. The speech analysis unit 16 thus ascertains separately for each recognized speaker in which chronological sequence the foreign speech intervals of this individual speaker stand with the own speech intervals (and thus how this speaker interacts with the user).

On the basis of the above-described analysis, the speech analysis unit 16 carries out an interaction classification, in the course of which each speaker—as described above—is classified as a “main speaker” or as a “secondary speaker”.

The speech analysis unit 16 preferably evaluates multiple of the above-described characteristic variables in a comparative analysis, in particular one or more characteristic variables relevant for the “turn-taking”, the orientation and the distance of the respective speaker to the head of the user, the level of the voice component of the respective speaker, and optionally also the level of the voice component of the user and/or the fundamental frequency of the voice component of the speaker and also optionally the fundamental frequency of the voice component of the user.

As indications that a specific speaker is a main speaker, the speech analysis unit 16 evaluates:

a) the finding that the user primarily faces toward this speaker during the foreign speech intervals assigned to this speaker, so that the voice component of this speaker predominantly comes from the front; the user facing toward the speaker is assessed as an indication that the user intentionally listens to the speaker, independently of whether or not the speaker directly addresses the user;
b) the finding that the user and this speaker predominantly speak chronologically synchronized (in particular alternately), so that own speech intervals and foreign speech intervals of this speaker are in a chronologically correlated sequence. The speech analysis unit 16 recognizes this in particular from a comparatively high frequency of SWITCHES and/or a comparatively low frequency of OVERLAPS and/or a comparatively low frequency of LAPSES in the communication between the user and this speaker. For example, the speech analysis unit 16 compares for this purpose the frequencies of SWITCHES, OVERLAPS, and LAPSES to corresponding threshold values in each case. A chronologically correlated sequence of the speech contributions of the user and a speaker is, on the one hand, a characteristic of a mutual conversation between the speaker and the user. A correlated sequence of the speech contributions may also permit a communication situation to be recognized in which a speaker wishes to come into contact with the user, even if the user possibly does not notice this at all, or a communication situation in which the user interrupts own speech contributions in order to listen to the speaker;
c) the finding that this speaker (absolutely or in comparison to other speakers) is located in a specific distance range to the head of the user; this is based on the finding that speech partners frequently assume a comparatively narrowly bounded distance (of, for example, between 80 cm and 2 m; depending on the cultural space of the user and the speakers, the ambient level, the conversation location, and the group size) to one another, while closer or farther distances between conversation partners rarely occur. The speech analysis unit 16 compares for this purpose the distance of the speaker to the head of the user to stored threshold values. These threshold values can be permanently specified or varied depending on the user. A reduction of the distance between the user and the speaker, in particular if it is chronologically correlated with speech contributions of the user and/or this speaker, is optionally also evaluated as an indication of a direct communication relationship; and
d) the finding that the voice component of this speaker is within a predetermined level range; this is based on the finding that conversation partners generally adapt the volume of their own voice so that it can be heard well in each case by the other conversation partner in dependence on the ambient conditions, and is neither too soft nor too loud at the same time. The predetermined level range is optionally varied here in dependence on the interference noise level. An increase of the level of the speaker is optionally also evaluated as an indication of an attempt to make contact of the speaker with the user.

The speech analysis unit 16 optionally additionally evaluates signals of the physiology analysis unit 18 in the interaction classification. As an indication that a specific recognized speaker is a main speaker, the speech analysis unit 16 evaluates here the finding that the signals of the biosensor 19 (or, if the hearing aid 2 accesses signals of multiple biosensors, at least one of these signals) evaluated by the physiology analysis unit 18 displays a change correlated chronologically with the foreign speech intervals of this speaker; determining a physiological reaction correlated with foreign speech intervals of a specific speaker permits increased attentiveness of the user, and thus intentional listening of the user, to be concluded.

The speech analysis unit 16 classifies a specific recognized speaker in particular as the main speaker here in the course of the interaction classification if multiple (for example at least two or at least three) of the above-described indications are fulfilled for this speaker. Otherwise, this speaker is classified as a secondary speaker. This classification is chronologically variable. A speaker classified as a main speaker can be reclassified as a secondary speaker and vice versa.

Depending on whether a specific recognized speaker was classified as a main speaker or secondary speaker, the voice components of this speaker are processed differently in the input audio signal I by the signal processor 12. A foreign speech interval, if the speaker assigned to this speech interval was classified as a main speaker:

a) is amplified with a greater amplification factor,
b) is dynamically compressed to a lesser extent,
c) is subjected to an interference noise and/or feedback suppression to a lesser extent, and/or
d) is subjected to direction-dependent damping to a greater extent

than a foreign speech interval whose assigned speaker was classified as a secondary speaker.

If the input audio signal I contains voice components of multiple speakers at a specific point in time, the voice components of these multiple speakers separated by source separation are differently processed in a corresponding way by the signal processor 12 for the or each speaker classified as a main speaker and the or each speaker classified as a secondary speaker.

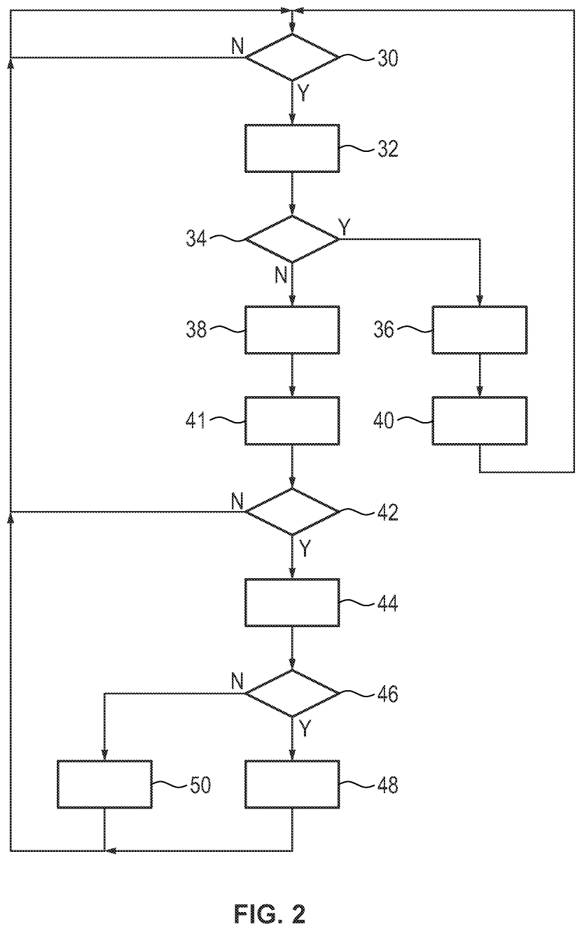

A concrete sequence of the method carried out by the hearing system 2 is illustrated by way of example in FIG. 2. Accordingly, the voice recognition unit 14 checks in normal operation of the hearing aid 4 in a step 30 whether the input audio signal I contains spoken speech. If this is the case (Y), the voice recognition unit 14 causes the signal processor 12 to carry out a following step 32. Otherwise (N), step 30 is repeated by the voice recognition unit 14. The voice recognition unit 14 separates speech intervals of the input audio signal I from intervals without voice component in this way. Step 32 and the further steps of the method following this are only carried out in recognized speech intervals.

In step 32, a source separation is carried out by the signal processor 12. The signal processor 12 recognizes spatially different noise sources (in particular speaking persons) in the input audio signal I here by applying beamforming algorithms and separates the signal components corresponding to each of these noise sources from one another in order to enable different processing of these signal components. The input audio signal I generally only contains the voice component of a single speaking person (namely of the user or a speaker different therefrom).

In a following step 34, it is checked by the speech analysis unit 16 whether the voice component recognized in the input audio signal I (or possibly one of the voice components recognized in the input audio signal I) contains the user's own voice. If this is the case (Y), a following step 36 is thus applied to this voice component by the speech analysis unit 16.

Otherwise (N), i.e., to voice components of the input audio signal I which contain the voice of a speaker different from the user, a step 38 is applied by the speech analysis unit 16. In this way, own speech intervals and foreign speech intervals in the input audio signal I are analyzed separately from one another by the speech analysis unit 16.

To ascertain the characteristic variables relevant for the “turn-taking”, the speech analysis unit 16 ascertains the starting and end points in time for the or each recognized own speech interval in step 36.

In a following step 40, the speech analysis unit 16 effectuates the setting of signal processing parameters of the signal processor 12, which are optimized for the processing of the user's own voice, for the recognized own speech interval. The signal processor 12 then returns to step 30 in carrying out the method.

For each recognized foreign speech interval, the speech analysis unit 16 identifies in step 38 the respective speaker, in that it ascertains characteristics (orientation, distance, fundamental frequency, speech rhythm) of the voice component in the input audio signal I in the above-described way and compares them to corresponding reference values of stored speaker profiles. The speech analysis unit 16 assigns the respective foreign speech interval—if possible—to a compatible speaker profile or otherwise applies a new speaker profile. The speech analysis unit 16 also checks here which speakers are active in the current hearing situation of the user. Speaker profiles which cannot be assigned to a foreign speech interval over a specific time period (for example, depending on the group size of the speakers and the hearing environment) are deleted by the speech analysis unit 16.

The speech analysis unit 16 also detects for each of the identified speakers, in a step 41, the starting and end points in time of the respective assigned foreign speech intervals in order to ascertain the characteristic variables relevant for the “turn-taking”.

In a step 42, the speech analysis unit 16 checks whether more than one speaker is active in the current hearing situation of the user, i.e., whether more than one of the stored speaker profiles is present or active.

In this case (Y), the speech analysis unit 16 carries out a following step 44. Otherwise (N), the signal processor 12 jumps back to step 30. The further method is therefore only carried out in multispeaker environments.

In step 44, the speech analysis unit 16 ascertains, on the basis of the starting and end points in time of own and foreign speech intervals recorded in steps 36 and 41, the characteristic variables relevant for the turn-taking between the user and each identified speaker (TURNS, PAUSES, LAPSES, OVERLAPS, SWITCHES) and their length and/or chronological frequency.

In a following step 46, the speech analysis unit 16 carries out the above-described interaction classification. It judges here whether multiple of the above-mentioned indications for a direct communication relationship between the user and the speaker to which the presently checked foreign speech interval is assigned are fulfilled.

If this is the case (Y), the speech analysis unit 16 classifies this speaker as a main speaker and notes this classification in the associated speaker profile. It then effectuates, in a step 48, the setting of hearing aid parameters which are optimized for the processing of voice components of a main speaker for the relevant foreign speech interval, in particular:

a) a comparatively high amplification of the input audio signal I,
b) a comparatively low dynamic compression, and
c) a comparatively strong direction-dependent damping (beamforming) of the input audio signal I, wherein the directional lobe of the beamforming algorithm is aligned in particular corresponding to the orientation of this main speaker to the head of the user.

Otherwise (N), the speech analysis unit 16 classifies this speaker as a secondary speaker and also notes this classification in the associated speaker profile. It then effectuates, in a step 50, the setting of hearing aid parameters which are optimized for the processing of voice components of a secondary speaker for the relevant foreign speech interval, in particular:

a) a comparatively low amplification of the input audio signal I,
b) a comparatively strong dynamic compression, and
c) a comparatively low direction-dependent damping.

In both cases, i.e., both after step 48 and also after step 50, the signal processor 12 subsequently returns back to step 30.

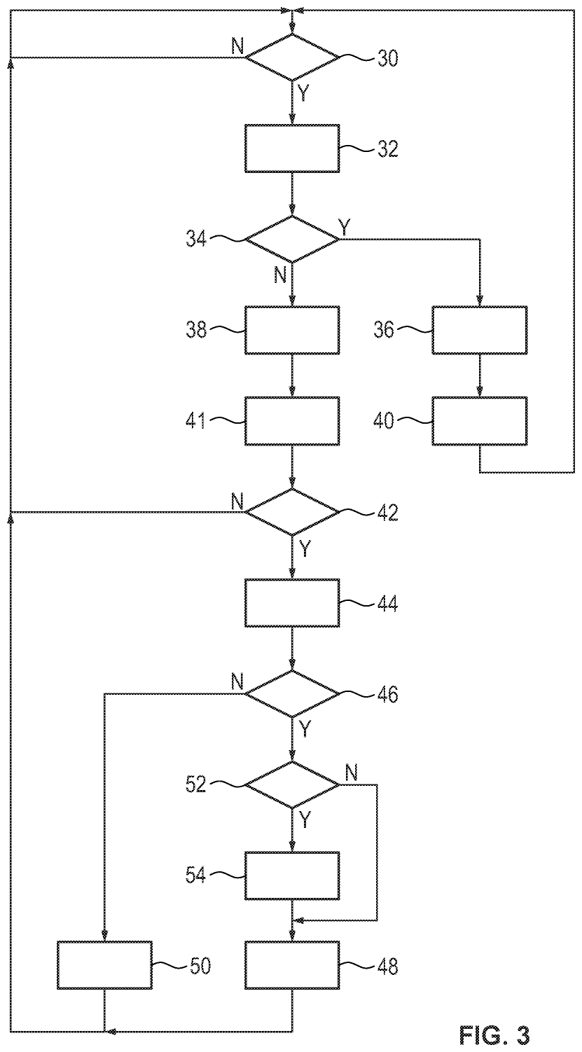

A variant of the method from FIG. 2 is shown in FIG. 3. The method according to FIG. 3 corresponds in large part to the method described above on the basis of FIG. 2. In particular, it comprises above-described steps 30 to 50. However, the method according to FIG. 3 additionally contains two additional steps 52 and 54.

Step 52 is carried out after the interaction classification (step 46), if the speaker who is assigned the current foreign speech interval was classified as a main speaker.

The speech analysis unit 16 checks in this case on the basis of the characteristic variables relevant for the turn-taking, on the basis of the volume and the fundamental frequency of the user's own voice in a preceding own speech interval, the volume and fundamental frequency of the voice of the speaker in the current foreign speech interval, and also optionally on the basis of the signals of the or each biosensor 19 evaluated by the physiology analysis unit 18 whether a difficult hearing situation (i.e., linked to increased listening effort and/or to frustration of the user) exists.

If this is the case (Y), in step 54, the speech analysis unit 16 effectuates an adaptation of the signal processing parameters to be set in step 48. For example, the speech analysis unit 16 increases the amplification factor to be applied to the processing of voice components of a main speaker or reduces the dynamic compression to be applied in this case.

Otherwise (N), i.e., if the check performed in step 52 does not result in an indication of a difficult hearing situation, the sequence skips step 54 in carrying out the method.

The signal processing parameters are thus adapted as needed in a type of control loop by steps 52 and 54 in order to facilitate the comprehension of the direct communication partner or partners (main speaker) for the user in difficult hearing situations. The adaptations to the signal processing parameter performed in step 54 are reversed successively if the difficult hearing situation is ended and thus the check performed in step 52 has a negative result over a specific time period.

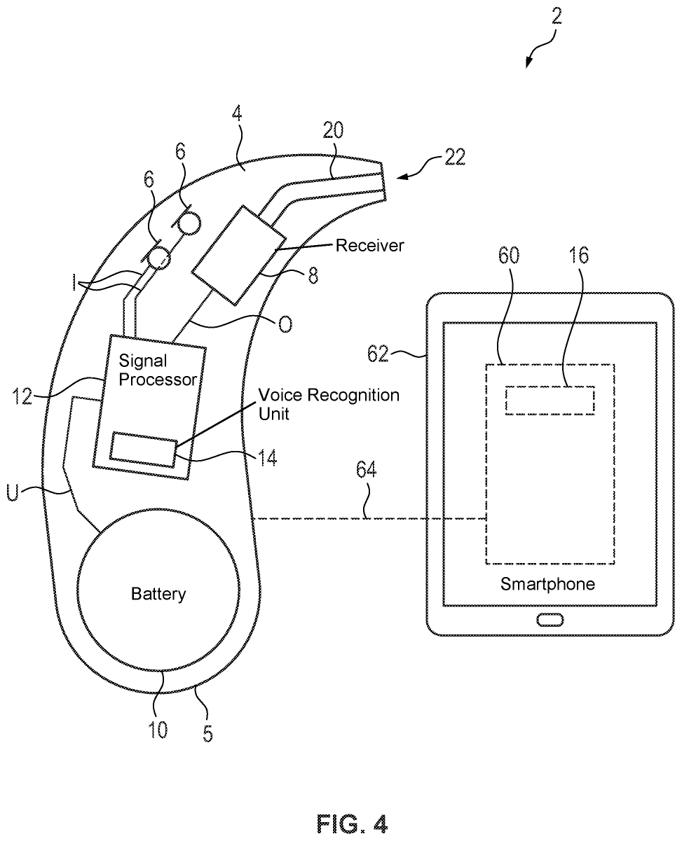

FIG. 4 shows a further embodiment of the hearing system 2, in which it comprises control software in addition to the hearing aid 4 (or two hearing aids of this type for supplying both ears of the user). This control software is referred to hereinafter as a hearing app 60. The hearing app 60 is installed in the example shown in FIG. 4 on a smartphone 62. The smartphone 62 is not part of the hearing system 2 itself here. Rather, the smartphone 62 is only used by the hearing app 60 as a resource for storage space and processing power.

The hearing aid 4 and the hearing app 62 exchange data in operation of the hearing system 2 via a wireless data transmission connection 64. The data transmission connection 64 is based, for example, on the Bluetooth standard. The hearing app 62 accesses a Bluetooth transceiver of the smartphone 62 for this purpose, in order to receive data from the hearing aid 4 and transmit data to it. The hearing aid 4 in turn comprises a Bluetooth transceiver in order to transmit data to the hearing app 60 and receive data from this app.

In the embodiment according to FIG. 4, parts of the software components required for carrying out the method according to FIG. 2 or FIG. 3 are not implemented in the signal processor 12, but rather in the hearing app 60. For example, in the embodiment according to FIG. 4, the speech analysis unit 16 or parts thereof are implemented in the hearing app 60.

The invention is particularly clear from the above-described exemplary embodiments but is also not restricted to these exemplary embodiments. Rather, further embodiments of the invention can be derived by a person skilled in the art from the claims and the above description.

The following is a summary list of reference numerals and the corresponding structure used in the above description of the invention:
2 hearing system
4 hearing aid
5 housing
6 microphone
8 receiver
10 battery
12 signal processor
14 (voice recognition) unit
16 (speech analysis) unit
18 physiology analysis unit
19 biosensor
20 auditory canal
22 tip
30 step
32 step
34 step
36 step
38 step
40 step
41 step
42 step
44 step
46 step
48 step
50 step
52 step
54 step
60 hearing app
62 smartphone
64 data transmission connection
U supply voltage
I (input) audio signal
O (output) audio signal

1. A method for operating a hearing system for assisting a sense of hearing of a user, the hearing system having at least one hearing instrument worn in or on an ear of the user, which comprises the steps of:
receiving a sound signal from an environment of the at least one hearing instrument by means of an input transducer of the at least one hearing instrument;
modifying a received sound signal in a signal processing step to assist the sense of hearing of the user;
outputting a modified sound signal by means of an output transducer of the hearing instrument;
performing an analysis step which includes the substeps of:
recognizing foreign speech intervals in which the received sound signal contains speech of a speaker different from the user;
identifying various speakers in recognized foreign speech intervals, and wherein each foreign speech interval is assigned to the speaker who speaks in the foreign speech interval;
classifying, for each recognized foreign speech interval, the speaker in a course of an interaction classification as to whether the speaker is in a direct communication relationship with the user as a main speaker or whether the speaker is not in a direct communication relationship with the user as a secondary speaker; and
carrying out a modification of the recognized foreign speech intervals in dependence on the interaction classification in the signal processing step.

2. The method according to claim 1, wherein in the analysis step, for at least one identified speaker, a spatial orientation of the at least one identified speaker relative to a head of the user is detected and taken into consideration in the interaction classification.

3. The method according to claim 1, wherein:
in the analysis step, own speech intervals are also recognized, in which the received sound signal contains speech of the user; and
for at least one identified speaker, a chronological sequence of assigned foreign speech intervals and recognized own speech intervals are detected and taken into consideration in the interaction classification.

4. The method according to claim 1, wherein in the analysis step, for each said recognized foreign speech interval, an averaged volume and/or a signal-to-noise ratio is ascertained and taken into consideration in the interaction classification.

5. The method according to claim 1, wherein in the analysis step, for each said recognized foreign speech interval, a physiological reaction of the user is detected and taken into consideration in the interaction classification.

6. The method according to claim 1, wherein the signal processing step contains the further substeps of:
amplifying the foreign speech intervals of the or each speaker classified as the main speaker to a greater extent than the foreign speech intervals of the or each speaker classified as the secondary speaker; and/or
dynamically compressing the foreign speech intervals of the or each speaker classified as the main speaker to a greater extent than the foreign speech intervals of the or each speaker classified as the secondary speaker; and/or
subjecting the foreign speech intervals of the or each speaker classified as the main speaker to less noise reduction and/or feedback suppression than the foreign speech intervals of the or each speaker classified as the secondary speaker; and/or
subjecting the foreign speech intervals of the or each speaker classified as the main speaker to direction-dependent damping to a greater extent than the foreign speech intervals of the or each speaker classified as the secondary speaker.

7. The method according to claim 1, wherein:
for the or each speaker classified as the main speaker a measure of a communication quality is detected which is characteristic for a success of an information transfer between the main speaker and the user and a listening effort of the user linked thereto; and
in the signal processing step, a modification of the foreign speech intervals assigned to the main speaker takes place in dependence on the measure of the communication quality.

8. The method according to claim 7, wherein a spatial orientation of the or each main speaker relative to a head of the user is detected and wherein the measure of the communication quality is ascertained on a basis of the spatial orientation.

9. The method according to claim 7, wherein:
own speech intervals are recognized in which the received sound signal contains the speech of the user;
a chronological sequence of assigned foreign speech intervals and recognized own speech intervals is detected for the or each main speaker, and wherein the measure of the communication quality is ascertained on a basis of the chronological sequence.

10. The method according to claim 7, wherein for each said foreign speech interval of the or each main speaker, a physiological reaction of the user is detected and wherein the measure of the communication quality is ascertained on a basis of the physiological reaction.

11. The method according to claim 7, wherein for at least one own speech interval, a spectral property of a voice of the user is ascertained and/or wherein for at least one said foreign speech interval assigned to the main speaker, a spectral property of the voice of the main speaker is ascertained, and wherein the measure of the communication quality is ascertained on a basis of the spectral property of the voice of the user or on a basis of the spectral property of the voice of the main speaker, respectively.

12. The method according to claim 7, wherein for at least one own speech interval, a volume is ascertained and/or wherein for at least one said foreign speech interval assigned to the main speaker, a volume is ascertained, and wherein the measure of the communication quality is ascertained on a basis of the volume of the own speech interval or foreign speech interval, respectively.

13. The method according to claim 7, wherein for at least one own speech interval, a speech rhythm is ascertained and/or wherein for at least one said foreign speech interval assigned to the main speaker, a speech rhythm is ascertained, and wherein the measure of the communication quality is ascertained on a basis of the speech rhythm of the user or the main speaker, respectively.

14. A hearing system for assisting a sense of hearing of a user, the hearing system comprising:
at least one hearing instrument worn in or on an ear of the user, said at least one hearing instrument, containing:
an input transducer for receiving a sound signal from an environment of said at least one hearing instrument;
a signal processor for modifying a received sound signal to assist the sense of hearing of the user;
an output transducer for outputting a modified sound signal; and
said at least one hearing instrument configured to perform an analysis step which includes the substeps of:
recognize foreign speech intervals in which the received sound signal contains speech of a speaker different from the user;
identify various speakers in recognized foreign speech intervals, and wherein each foreign speech interval is assigned to the speaker who speaks in the foreign speech interval;
classify, for each recognized foreign speech interval, the speaker in a course of an interaction classification as to whether the speaker is in a direct communication relationship with the user as a main speaker or whether the speaker is not in a direct communication relationship with the user as a secondary speaker; and
carrying out a modification of the recognized foreign speech intervals in dependence on the interaction classification in said signal processor.
